(19) United States
(12) Patent Application Publication
(10) Pub. No.: US 2026/0154824 A1
(43) Pub. Date: Jun. 4, 2026

(54) ANALYSIS OF MOVEMENTS IN A VIDEO DATA STREAM

(71) Applicant: Robert Bosch GmbH, Stuttgart (DE)

(72) Inventors: Xinyang Wu, Zuerich (CH); Volker Fischer, Renningen (DE)

(21) Appl. No.: 19/402,148

(22) Filed: Nov. 26, 2025

(30) Foreign Application Priority Data
Dec. 4, 2024 (DE) 10 2024 211 603.3

(51) Int. Cl. G06T 7/20; G06V 10/62; G06V 10/762; G06V 20/56

(52) U.S. Cl. CPC G06T 7/20; G06V 10/62; G06V 10/762; G06T 2207/10016; G06T 2207/30004; G06T 2207/30232; G06T 2207/30252; G06V 20/56

(57) ABSTRACT

A method for analyzing a video data stream which includes a sequence of images. The method includes: representing each individual image of the sequence as a superposition of functions that provide location-dependent contributions to this individual image; generating, from parameters that characterize this superposition, a representation of the individual image in a workspace; ascertaining, for at least one of the parameters, at least one time program in such a way that earlier images in the sequence, in conjunction with the time program, are used to provide an accurate prediction for later images in the sequence; and evaluating movements in the sequence of images from the at least one time program.

### FIELD

The present invention relates to the analysis of a video data stream which comprises a sequence of images with respect to movements, such as of objects.

### BACKGROUND INFORMATION

The at least partially automated driving of vehicles or robots on company premises, or even in public road traffic, requires continuous monitoring of the environment of the vehicle or robot. For such environmental monitoring, in particular video cameras, for example, are used as a source of information.

Changes in the scenery in the environment of the vehicle or robot are of particular importance for planning the future behavior of the vehicle or robot, such as the trajectory to be followed. For example, if objects move in the scenery, this may be a reason to adjust the behavior of the vehicle or robot. For example, if a person steps onto the road from concealment between parked cars, an evasive maneuver or emergency braking may be necessary.

### SUMMARY

The present invention provides a method for analyzing a video data stream. This video data stream comprises a sequence of images. The images could have been taken using any technique. In addition to a visible light camera, other sensors such as a thermal imaging camera, an ultrasonic sensor, a radar sensor and/or a lidar sensor can in particular also be used. This means that the individual images may also have been generated in a multimodal way.

According to an example embodiment of the present invention, as part of the method, each individual image is represented as a superposition of functions that provide location-dependent contributions to this individual image. A representation of the individual image is generated in a workspace from parameters that characterize this superposition. The parameters of the superposition thus acquire a spatial reference. This means that the parameters are significantly less abstract than, for example, the entries in feature maps supplied by convolutional neural networks, in which a spatial reference can only be constructed indirectly via the so-called “receptive field.” This means that the representations in this workspace, taken in isolation, have a more insightful meaning than, for example, representations in the space of feature maps.

Thus, the sequence of individual images creates a sequence of representations in the workspace. Any conventional method can be used to create these representations. For example, the individual images can be used with a trained machine learning model, such as Flash3D.

A time program is then ascertained for at least one of the parameters in such a way that earlier images in the sequence, in conjunction with the time program, are used to provide an accurate prediction for later images in the sequence. Movements in the sequence of images are evaluated from at least one time program.

It has been recognized that movements can be ascertained more directly from the time program of the parameters than, for example, from an optical flow that describes changes between individual images in the original pixel space. Since, as explained above, the parameters of the superposition already contain a spatial reference, their change already relates to movements in terms of content.

In particular, in scenery in which there is a plurality of moving object instances, these moving object instances can be identified and distinguished from one another. This is possible even without any knowledge of the classes to which these object instances belong. In this respect, the human perception of scenery having a plurality of object instances can be simulated. This perception is likewise based on the fact that moving object instances can be identified and distinguished from one another even without knowing what each of them is in detail.

In particular, it is also possible to recognize object instances of rare types, for which a neural network or other conventional object detector may not be trained. For example, unusual pieces of cargo, such as pieces of furniture, can easily be lost on the motorway due inadequate securing of loads. On the basis of the time program of the parameters, it is then possible, for example, to recognize when such a piece of cargo detaches from a vehicle driving ahead.

Often, in a sequence of images, only a portion of the image region is affected by movements at all. Time programs of parameters that change during movement are a compact representation (“sparse flow”) of the movement, which requires significantly less memory and computing power compared to an optical flow. This is particularly advantageous for applications on board vehicles or robots. There, the amount of hardware that can be carried, along with the power supply, is generally very limited.

Furthermore, the evaluation of movements using time programs of parameters is more robust with respect to noise and the occurrence of only weakly textured image regions. For this purpose, the affected functions that provide location-dependent contributions can be ranked and filtered by dimensional scales. This ensures, in particular, stable and accurate recognition of movements in the relevant regions in the environment of the vehicle, in particular during real-world driving operation.

Finally, the flow expressed in time programs of parameters is also immediately understandable and transparent, in particular with regard to the already given spatial reference of the functions that provide location-dependent contributions to the individual image. It is easily recognizable if, for certain portions of the image, the flow takes a completely different or even noticeably wrong direction.

In a particularly advantageous example embodiment of the present invention, ascertaining the time program involves
ascertaining, from earlier images in the sequence and using a candidate time program, a prediction for at least one later image in the sequence,
comparing this prediction with the actual later image in the sequence, and
ascertaining, on the basis of a deviation determined in this comparison, a change of the candidate time program that is expected to reduce the deviation.

This means that the candidate time program can be gradually optimized until the predictions of later images in the sequence, ascertained using said time program, are sufficiently accurate. It can then be assumed that the candidate time program of the at least one parameter of the superposition describes the changes in the scenery with sufficient accuracy.

This optimization also requires no “labeling” of object instances with class memberships or other prior knowledge. Instead, only information that is already present in the sequence of individual images is needed. By eliminating the “labeling,” both a significant cost factor and a strong subjective element are removed.

The optimization can be initialized, for example, with an empty time program. However, in many cases, it may be more useful to initialize with a previously ascertained time program, for example for the previous pair of individual images.

The deviation can be ascertained using any measure, such as the mean squared error. In addition, the deviation can be further enriched with additional terms that, for example, compare image statistics or “penalize” the occurrence of certain artifacts in a targeted manner.

In a particularly advantageous example embodiment of the present invention, a parameterized approach with a set of free time program parameters is selected for the time program. This means that the parameters of the superposition are made time-dependent, and this time dependency in turn is characterized by the time program parameters. These time program parameters can be optimized using any optimization method in order to minimize the deviation between the prediction and the subsequent actual image in the sequence. The time program parameters can in particular, for example, be continuous, so that a proposed change can be ascertained from an existing deviation, which is expected to reduce the deviation. If the time program parameters assume discrete (e.g., integer) values, a search space spanned by these time program parameters can, for example, be searched according to a specified scheme.

In a further particularly advantageous example embodiment of the present invention, the dependency of the superposition on the free time program parameters can be differentiated. In particular, for example starting from a given superposition of functions, parameters on which the superposition depends in a differentiable way can be selected and made time-dependent, with a time program that is itself differentiable. For example, the functions that provide the location-dependent contributions to the individual image and their combination to form the superposition can be selected in a targeted manner in such a way that there are parameters therein on which the result of the superposition depends in a differentiable way. These can then, in turn, be made time-dependent using a time program that can itself be differentiated. From an existing deviation between the prediction for a later image in the sequence, and the actual later image in the sequence, it can then be calculated which of the free time program parameters contributed to this deviation and to what extent. This then results in a proposed change to the time program parameters, which is expected to reduce the deviation. This is somewhat analogous to the backpropagation of the value of a cost function (loss function) used to assess the performance of a neural network, to the parameters (such as weights) that characterize the behavior of such neural network.

In a further particularly advantageous embodiment of the present invention, at least one parameter of the superposition comprises a velocity at which another parameter of the superposition changes. The time program for such parameters then contains a velocity field that has a much more insightful meaning than, for example, the optical flow, which describes the change from one pixel image to the next. If the parameters of the superposition comprise, for example, a position in the spatial coordinates x, y and z, velocities dx, dy and dz, at which such spatial coordinates x, y and z change, can be added as further parameters. A time program for these velocities dx, dy and dz then also results in a time program for the spatial coordinates x, y and z.

In particular, those parameters of the superposition on the basis of which the given individual images can be reconstructed can be excluded from the time program. The time program can then, in particular, only extend to parameters that have been specifically added to ascertain movements, such as the aforementioned velocities at which other parameters change. This means that the representations of the individual images as such remain untouched, and the possibility of ascertaining predictions for future individual images or interpolating intermediate images between existing individual images is added purely additively. This is an important difference with respect to conventional methods, such as “4D Gaussian splatting,” where both the spatial coordinates x, y, z and their time evolutions dx, dy, dz are put up for discussion again: such a complete optimization may well accept that reconstructions of the given individual images deteriorate in order to even better capture the dynamics in the sequence of individual images. The method proposed here, however, captures this dynamic under the constraint that the reconstructions of the individual images remain the same.

In a further particularly advantageous example embodiment of the present invention, the time program for at least one parameter comprises an evolution of this parameter over time, which evolution is linear at least in portions. This evolution can be ascertained using linear optimization methods. For example, a gradient descent method and/or a method based on solving a system of linear equations can be used.

In a further particularly advantageous example embodiment of the present invention, a sequence of images is selected in which the individual images follow one another at a rate of 10 Hz or more. Then, the evolution between two successive individual images is not quantitatively too large, and the temporal evolution can be linearized.

In a further particularly advantageous example embodiment of the present invention, the parameters that characterize the superposition comprise
parameters that characterize the behavior of individual functions,
parameters that characterize the type and/or strength of the effect of individual functions on the image generated by the superposition, along with
parameters that characterize the relative weighting of a plurality of functions with respect to one another.

For example, certain parameters can characterize the extent to which functions are shifted, rotated or compressed along one or more coordinate axes. The type and/or strength of the effect of individual functions can be determined, for example, by parameters that define the colors and/or opacity with which the location-dependent contributions of the functions are transferred to the superposition. Parameters that characterize the relative weighting of a plurality of functions with respect to one another can be, for example, coefficients of a linear combination or of another type of aggregation.

In a particularly advantageous example embodiment of the present invention, at least one distribution function, which assigns a measure of probability to each location in the individual image, is selected as the function that provides location-dependent contributions to the individual image. These contributions are particularly easy to interpret and also well motivated. Thus, the representations composed of such contributions have, per se, a meaning that can be further evaluated particularly well, for example, by a downstream neural network (task network) trained for a specific task.

An example of such a distribution function is a probability density function of a Gaussian distribution, often referred to simply as a “Gaussian function.” Such a function can be characterized, for example, by
three parameters for the spatial shift in the three coordinate directions of Cartesian space,
three parameters for scaling in these three coordinate directions,
four parameters for the orientation of the function in space,
three parameters for specifying the color with which the function's contribution manifests in the superposition, in the three additive primary colors red, green, and blue, and
optionally, additional velocity vectors for translation and/or rotation.

All of these parameters are found in the arguments of the sine, cosine and exponential functions. Therefore, the Gaussian function can easily be differentiated according to these parameters.

In a further particularly advantageous example embodiment of the present invention, evaluating movements comprises filtering out movements that are consistent with the movement of a camera used to record the sequence of images. In this way, movements that do not originate from the movement of the camera can be identified. For example, if a vehicle or robot is moving in traffic and carries a camera, the recorded image changes in virtually every pixel simply because of this movement. That means that the image is full of optical flow. However, for further planning of the behavior of the vehicle or robot, objects that move of their own accord and could thus cross the trajectory of the vehicle or robot are particularly important. If, for example, a vehicle enters an intersection region from a side street or a pedestrian steps onto the road from concealment between parked cars, these movements can be readily distinguished from the ego-movement of the vehicle by means of the camera. The same applies if a vehicle driving ahead suddenly brakes, because then there is a clear difference in velocity between the movement of the vehicle with the camera and the movement of the vehicle driving ahead. As a result, these external movements, which are distinguished from the ego-movement, can be responded to more quickly. For example, an evasive maneuver or emergency braking may be indicated.

In a further particularly advantageous example embodiment of the present invention, evaluating movements comprises recognizing object instances shown in the sequence of images on the basis of their movements and/or distinguishing them from one another. In particular, the occurrence in the representations of an entity that exhibits consistent changes in spatially related parameters of the superposition can be interpreted as the occurrence of a moving object instance. Even objects that are close together can be easily distinguished from one another, provided that they move in different ways. This can be the case, for example, with pedestrians who have different intentions.

In particular, image components can be clustered in relation to the time programs of parameters. The clusters obtained in this process can be regarded as belonging to different object instances. Clustering can be performed using any method and is completely independent of the classes to which the object instances may belong. Any desired method can be used for the clustering, such as k-means clustering, DBSCAN or mean shift.

Thus, in a further particularly advantageous example embodiment of the present invention, at least one change to the candidate time program, and/or at least one change to a parameter of the superposition, can represent a change to a position and/or orientation in space.

In a further particularly advantageous example embodiment of the present invention, evaluating movements comprises interpolating an intermediate state of the scenery shown in the sequence of images between two individual images. Once the time program with which the parameters of the superposition change from one individual image to the next has been ascertained, any point in time between the recording of a first individual image and the recording of a second individual image can be selected. The time program for the parameters can then be evaluated for this point in time, and thus the superposition of functions can provide the desired intermediate state for this point in time. Thus, once the movement is understood by ascertaining the time program, any still image of this movement can be generated. In contrast to generating such intermediate images via generative models, it is ensured that the resulting still image is geometrically correct and does not contain heavily modified versions of the objects shown in the given individual images.

Similarly, for example, a new perspective on the scenery can be created by shifting location-dependent arguments of the functions in the superposition.

In a further particularly advantageous example embodiment of the present invention, a control signal is formed from the evaluated movements. A vehicle, a driver assistance system, a robot, a system for quality control, a system for monitoring regions, and/or a system for medical imaging is controlled with the control signal. Due to the more reliable movement recognition via the time programs of parameters, the likelihood is increased that the response executed by the particular controlled technical system in reaction to the control signal is appropriate for the sequence of single images.

The method can in particular be wholly or partially computer-implemented. The present invention therefore also relates to a computer program comprising machine-readable instructions that, when executed on one or more computers and/or compute instances, cause the computer(s) and/or compute instance(s) to execute the described method of the present invention. In this sense, control devices for vehicles and embedded systems for technical devices, which are also capable of executing machine-readable instructions, are also to be regarded as computers. Compute instances can, for example, be virtual machines, containers, or serverless execution environments, which can be provided in a cloud in particular.

The present invention also relates to a machine-readable data carrier and/or to a download product comprising the computer program. A download product is a digital product that can be transmitted via a data network, i.e., can be downloaded by a user of the data network, and can, for example, be offered for immediate download in an online shop.

Furthermore, one or more computers and/or compute instances can be equipped with the computer program, with the machine-readable data carrier, or with the download product.

Further measures improving the present invention are explained in more detail below, together with the description of the preferred exemplary embodiments of the present invention, with reference to the figures.

### BRIEF DESCRIPTION OF THE DRAWINGS

FIG. 1 shows an exemplary embodiment of the method 100 for analyzing a video data stream, according to the present invention.

FIG. 2 is an illustration of ascertaining movements 8 according to method 100 of the present invention.

FIG. 3 shows an application example for separating movements using the method 100 of the present invention.

### DETAILED DESCRIPTION OF EXAMPLE EMBODIMENTS

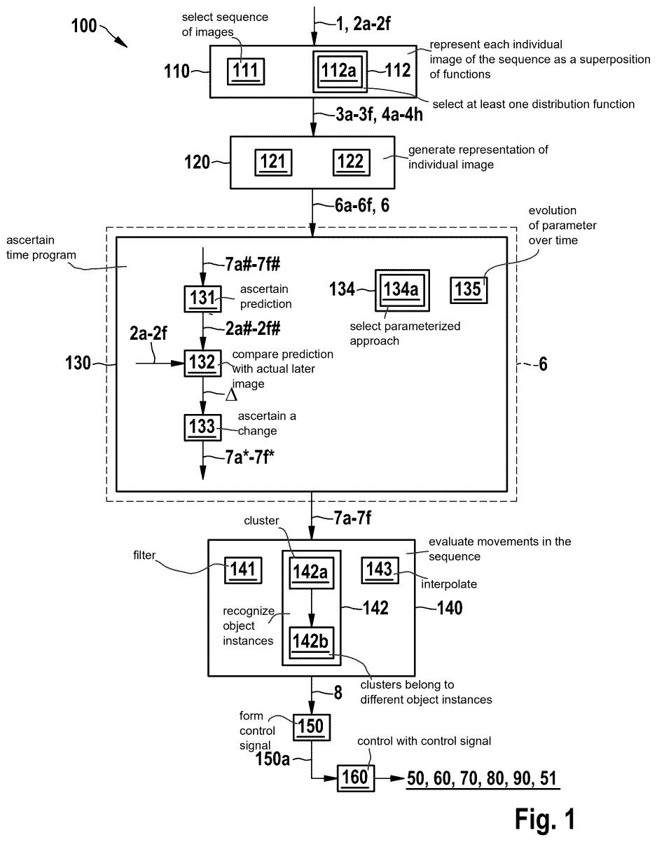

FIG. 1 is a schematic flow chart of an exemplary embodiment of the method 100 for analyzing a video data stream. The video data stream comprises a sequence 1 of images 2a-2f.

In step 110, each individual image 2a-2f of the sequence 1 is represented as a superposition 3a-3f of functions that provide location-dependent contributions 4a-4h to this individual image 2a-2f.

According to block 111, a sequence 1 of images can be selected in which the individual images 2a-2f follow one another at a rate of 10 Hz or more.

According to block 112, at least one distribution function that assigns a measure of probability to each location in the individual image 2a-2f can be selected as a function that provides location-dependent contributions 4a-4h to the individual image 2a-2f.

According to block 112a, at least one probability density function of a Gaussian distribution can be selected as the distribution function.

The superposition 3a-3f is characterized by parameters 5a-5f. These parameters 5a-5f can, for example, be contained in the arguments of the functions that provide the location-dependent contributions 4a-4h to the individual image 2a-2f. Alternatively or in combination therewith, parameters 5a-5f can, for example, define coefficients with which location-dependent contributions 4a-4h of the plurality of functions are aggregated. In step 120, a representation 6a-6f of the individual image 2a-2f is generated in a workspace 6 from these parameters 5a-5f.

According to block 122, the parameters 5a-5f that characterize the superposition 3a-3f can thus in particular comprise, for example:
parameters 5a-5f that characterize the behavior of individual functions,
parameters 5a-5f that characterize the type and/or strength of the effect of individual functions on the image generated by the superposition 3a-3f, and
parameters 5a-5f that characterize the relative weighting of a plurality of functions with respect to one another.

In step 130, at least one time program 7a-7f is ascertained for at least one of the parameters 5a-5f in such a way that earlier images 2a-2f in the sequence 1, in conjunction with the time program 7a-7f, are used to provide an accurate prediction 2a #-2f # for later images 2a-2f in the sequence 1.

Ascertaining the time program 7a-7f can in particular involve, for example,
in accordance with block 131, ascertaining, from earlier images 2a-2f in the sequence 1 and using a candidate time program 7a #-7f #, a prediction 2a #-2f # for at least one later image 2a-2f in the sequence 1,
in accordance with block 132, comparing this prediction 2a #-2f # with the actual later image 2a-2f in the sequence 1, and
in accordance with block 133, ascertaining, on the basis of a deviation Δ determined in this comparison, a change 7a*-7f* of the candidate time program 7a #-7f # that is expected to reduce the deviation Δ.

According to block 134, a parameterized approach with a set of free time program parameters can be selected for the time program 7a-7f. In this case, in particular according to block 134a, for example, the dependency of the superposition 3a-3f on the free time program parameters can be differentiated.

According to block 135, the time program 7a-7f for at least one parameter 5a-5f can involve an evolution of this parameter 5a-5f over time, which evolution is linear at least in portions.

In step 140, movements 8 in the sequence 1 of images 2a-2f are evaluated from at least one time program 7a-7f.

According to block 141, this evaluation of movements 8 can in particular comprise, for example, filtering out movements that are consistent with the movement of a camera used to record the sequence 1 of images 2a-2f. As explained above, the camera can, for example, be mounted on a vehicle or robot, so that the entire image constantly changes due to the ego-movement of the vehicle or robot.

According to block 142, the evaluation of movements 8 can in particular comprise, for example, recognizing object instances shown in the sequence 1 of images 2a-2f on the basis of their movements and/or distinguishing them from one another.

In particular according to block 142a, for example, image components can be clustered in relation to the time programs of parameters. According to block 142b, the clusters obtained in this case can then be regarded as belonging to different object instances.

According to block 143, evaluating movements 8 can comprise interpolating an intermediate state of the scenery shown in the sequence 1 of images 2a-2f between two individual images 2a-2f.

In the example shown in FIG. 1, a control signal 150a is formed in step 150 from the evaluated movements 8. In step 160, a vehicle 50, a driver assistance system 51, a robot 60, a system 70 for quality control, a system 80 for monitoring regions, and/or a system 90 for medical imaging, is controlled with the control signal 150a.

In one example, a representation 6a-6f can be expressed in parameters 5a-5f, which can be expressed as vectors G=(σᵢ, μᵢ, Σᵢ, cᵢ). A vector G describes a three-dimensional Gaussian distribution function, where
σᵢ∈[0.1) specifies the opacity,
μᵢ∈R³ specifies the mean (the center) of the distribution function,
Σᵢ∈R^{3×3} is the covariance matrix and
cᵢ:S²→R³ is the radiance (directed color) of each Gaussian component.

The distribution function can then be specified as

$${g}_{i}^{( x )} = exp ( - \frac{1}{2} ( x - {μ}_{i} ) T {\sum }_{i}^{- 1} ( x - {μ}_{i} ) ) .$$

The colors assigned to the distribution functions are typically specified using spherical harmonics, so that

$$G [ ci ( ν ) ] j = {\sum }_{l = 0}^{L} {\sum }_{l}^{m = - l} {c}_{ijlm} {Yl}_{m} ( v ) .$$

Here, v∈S² is a viewing direction, and Ylₘ are spherical harmonics of various orders m and degrees l.

The representation G defines the opacity and color functions of a radiance field as follows:
opacity at a point in 3D space

$$x ∈ {ℝ}^{3} : σ ( x ) = {\sum }_{i = 1}^{G} {σ}_{i} {g}_{i} ( x ) .$$

radiance at x in direction ν:

$$c ( x , v ) = \frac{{\sum }_{i = 1}^{G} {c}_{i} ( ν ) {σ}_{i} {g}_{i} ( x )}{{\sum }_{i = 1}^{G} {σ}_{i} {g}_{i} ( x )}$$

The field is rendered into an image J by integrating the radiance along the line of sight using the emission-absorption equation:

$$( u ) = {\int }_{0}^{∞} c ( {x}_{t} , ν ) σ ( {x}_{t} ) exp ( - {\int }_{0}^{t} σ ( {x}_{τ} ) d τ ) dt$$

Here, xt=x₀−tv is the ray that propagates from the camera center x₀ in the direction −ν toward the pixel u.

An efficient approximation of this integral is important for the reconstruction of images using “Gaussian splatting”. For this purpose, a differentiable rendering function \dot{J}=Rend(G,π) is set up, which takes as inputs the representation vector G and the viewpoint π and outputs an estimate \dot{J} of the image visible from this viewpoint.

A time dependency can then be added to the representation Gₜ, for example in the form of velocities dx, dy, and dz at which the coordinates x, y, and z change: G_{t+Δt}=Gₜ+ΔG·Δt.

In order to then obtain the “Gaussian flow” ΔG between the individual images recorded at points in time t and t+Δt, the following optimization problem can be solved:

$$Δ {G}_{t \to t + Δ t} = arg {min}_{Δ G} \vert {I}_{t + Δ t} - GS ( {G}_{t} + Δ G * Δ t ) \vert$$

Here, I_t+Δt is the image at the point in time t+Δt, |.| is an arbitrary distance function in the image space (such as L1, L2), GS( ) is the rendering function described above, and G_t is the representation for the point in time t, which was ascertained, for example, using Flash3D: G_t=Flash3D(I_t).

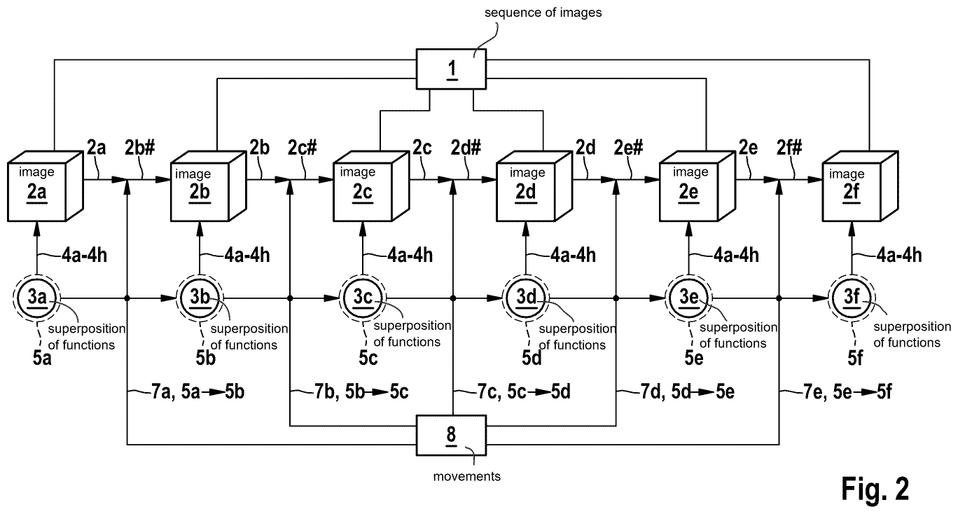

FIG. 2 illustrates the processing step using an exemplary sequence 1 of six individual images 2a-2f. Each individual image 2a-2f is represented as a superposition 3a-3f of functions that provide location-dependent contributions 4a-4h to the particular individual image 2a-2f. The superposition 3a-3f is characterized in each case by parameters 5a-5f.

Proceeding from a first individual image, for example 2a, and a second individual image, for example 2b, a time program, for example 7a, can be ascertained that leads from the parameters 5a for the first individual image 2a to the parameters 5b for the second individual image 2b. This time program, here 7a, can be combined with the first individual image, here 2a, to form a prediction, here 2b #, for the second individual image, here 2b. The time program 7a can be optimized to ensure that the prediction 2b # matches the actual individual image 2b as closely as possible.

The same procedure can be applied to any other pairings of individual images. From the ascertained time programs 7a-7e, the movement 8 in the sequence 1 of the individual images 2a-2f can be evaluated.

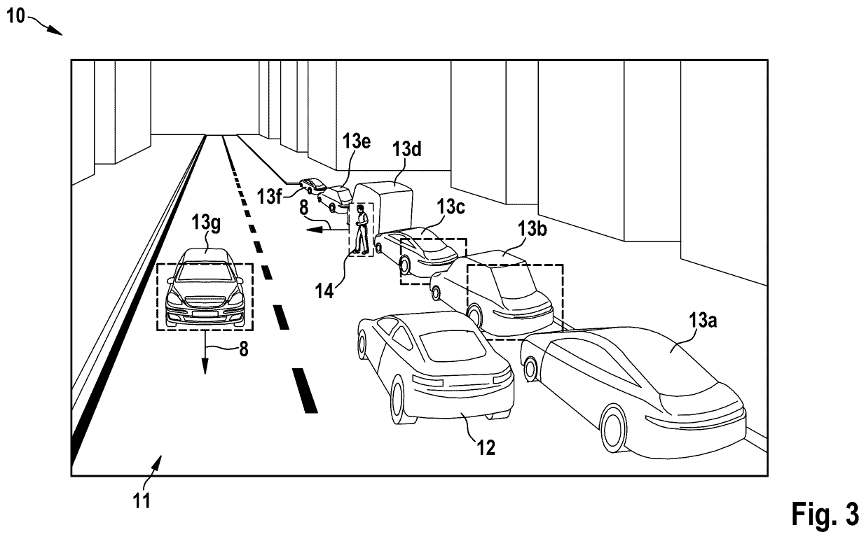

FIG. 3 illustrates a situation in which the method 100 proposed here makes it possible to distinguish important movements from unimportant movements. Shown is scenery 10 with a road 11, on which an ego vehicle 12 to be controlled is moving, along with other vehicles 13a-13g. The other vehicles 13a-13f are parked along the edge of the road 11, while the other vehicle 13g is approaching the ego vehicle 12 in the opposite lane. Additionally, a pedestrian 14 is stepping out of a gap between the other vehicles 13c and 13d onto the road 11.

A camera mounted on the ego vehicle 12 records images that constantly change due to the ego-movement of the ego vehicle 12. This means that when two consecutive individual images 2a-2f are compared, the entire image is full of movement. The method proposed here makes it possible to filter out all movement that is consistent with the ego-movement of the ego vehicle 12. The fact that the other vehicles 13a-13f and the road 11 move relative to the ego vehicle 12 is not a surprise, but rather to be expected due to the ego-movement of the ego vehicle 12. By contrast, only movements 8 of external objects that are not already to be expected due to the ego-movement of the ego vehicle 12, but instead arise from external intentions, are relevant for a possible adjustment of the future behavior of the ego vehicle.

Here, the other vehicle 13g is initially considered. This other vehicle 13g is indeed approaching the ego vehicle 12, but it is doing so on the opposite lane of the road 11 that is designated for that purpose. This alone does not yet require any adjustment of the planned behavior of the ego vehicle 12, namely to continue driving straight ahead in its own lane.

Far more critical is the behavior of the pedestrian 14, who is stepping onto the road 11 and thus directly into the lane in which the ego vehicle 12 is driving. Thus, the movement 8 of the pedestrian 14 necessitates an evasive maneuver or a braking maneuver of the ego vehicle 12. However, swerving is not an option, since the right-hand edge of the road in front of the ego vehicle 12 is occupied by the other vehicles 13b and 13c, and the vehicle 13g is moving in the opposite lane. Thus, the only correct reaction of the ego vehicle 12 is an emergency stop. The proposed method 100 makes it possible to find this solution faster by filtering out irrelevant movements of external objects that are to be expected anyway, rather than by analyzing the optical flow of an image in which all regions are in movement.

1-19. (canceled)

20. A method for analyzing a video data stream which includes a sequence of images, the method comprising the following steps:
representing each individual image of the sequence as a superposition of functions that provide location-dependent contributions to the individual image;
generating, from parameters that characterize the superposition of functions for each of the individual images, a representation of the individual image in a workspace;
ascertaining, for at least one of the parameters, at least one time program in such a way that earlier images in the sequence, in conjunction with the time program, are used to provide an accurate prediction for later images in the sequence; and
evaluating movements in the sequence of images from the at least one time program.

21. The method according to claim 1, wherein the ascertaining of the time program includes:
ascertaining, from earlier images in the sequence and using a candidate time program, a prediction for at least one later image in the sequence,
comparing the prediction for the at least one later image with the at least one later image in the sequence, and
ascertaining, based on a deviation determined in the comparison, a change of the candidate time program that is expected to reduce the deviation.

22. The method according to claim 20, wherein the time program is a parameterized approach with a set of free time program parameter.

23. The method according to claim 22, wherein a dependency of each superposition on the free time program parameters can be differentiated.

24. The method according to claim 20, wherein at least one parameter of the superposition includes a velocity at which another parameter changes.

25. The method according to claim 21, wherein at least one change of the candidate time program, and/or at least one change of a parameter of the superposition, represents a change to a position in space and/or orientation in space.

26. The method according to claim 20, wherein the time program for at least one parameter involves an evolution of the at least one parameter over time, which evolution is linear at least in portions.

27. The method according to claim 20, wherein a sequence of images is selected in which the individual images follow one another at a rate of 10 Hz or more.

28. The method according to claim 20, wherein the parameters that characterize the superposition include:
parameters that characterize a behavior of individual functions,
parameters that characterize a type and/or strength of the effect of individual functions on an image generated by the superposition, and
parameters that characterize a relative weighting of a plurality of functions with respect to one another.

29. The method according to claim 20, wherein at least one distribution function that assigns a measure of probability to each location in each individual image is selected as a function that provides the location-dependent contributions to the individual image.

30. The method according to claim 29, wherein at least one probability density function of a Gaussian distribution is selected as the at least one distribution function.

31. The method according to claim 20, wherein the evaluating of the movements includes filtering out movements that are consistent with a movement of a camera used to record the sequence of images.

32. The method according to claim 20, wherein the evaluation of the movements includes recognizing object instances shown in the sequence of images based on their movements and/or distinguishing object instances from one another.

33. The method according to claim 32, wherein image components are clustered in relation to time programs of the parameters and the clusters obtained here are regarded as belonging to different object instances.

34. The method according to claim 20, wherein the evaluating of the movements includes interpolating an intermediate state of scenery shown in the sequence of images between two of the individual images.

35. The method according to claim 20, wherein
a control signal is formed from the evaluated movements, and
a vehicle, and/or a driver assistance system, and/or a robot, and/or a system for quality control, and/or a system for monitoring regions, and/or a system for medical imaging, is controlled with the control signal.

36. A non-transitory machine-readable data carrier on which is stored a computer program including machine-readable instructions for for analyzing a video data stream which includes a sequence of images, the instructions, when executed by one or more computers and/or compute instances, cause the one or more computers and/or compute instances to perform the following steps comprising:
representing each individual image of the sequence as a superposition of functions that provide location-dependent contributions to the individual image;
generating, from parameters that characterize the superposition of functions for each of the individual images, a representation of the individual image in a workspace;
ascertaining, for at least one of the parameters, at least one time program in such a way that earlier images in the sequence, in conjunction with the time program, are used to provide an accurate prediction for later images in the sequence; and
evaluating movements in the sequence of images from the at least one time program.

37. One or more computers and/or compute instances including a machine-readable data carrier on which is stored a computer program including machine-readable instructions for for analyzing a video data stream which includes a sequence of images, the instructions, when executed by the one or more computers and/or compute instances, cause the one or more computers and/or compute instances to perform the following steps comprising:
representing each individual image of the sequence as a superposition of functions that provide location-dependent contributions to the individual image;
generating, from parameters that characterize the superposition of functions for each of the individual images, a representation of the individual image in a workspace;
ascertaining, for at least one of the parameters, at least one time program in such a way that earlier images in the sequence, in conjunction with the time program, are used to provide an accurate prediction for later images in the sequence; and
evaluating movements in the sequence of images from the at least one time program.
